(19) United States
(12) Patent Application Publication
(10) Pub. No.: US 2012/0023675 A1
(43) Pub. Date: Feb. 2, 2012

(54) TOOL-REMOVABLE SLIDE-OFF FOOTBOARD

(76) Inventors: Stephen E. HUTCHISON, Batesville, IN (US); Richard H. Heimbrock, Cincinnati, OH (US)

(21) Appl. No.: 12/957,556

(22) Filed: Dec. 1, 2010

Related U.S. Application Data
(60) Provisional application No. 61/369,466, filed on Jul. 30, 2010.

(51) Int. Cl. A61G 7/075; A61G 7/05

(52) U.S. Cl. 5/624

(57) ABSTRACT

A patient support apparatus includes a deck configured to support a mattress assembly thereon; and a footboard removably coupled to the deck. The footboard includes a latch mechanism movable between a locked position wherein the latch mechanism is engaged with the deck to prevent the footboard from being removed from the deck and an unlocked position wherein the latch mechanism is disengaged from the deck to allow the footboard to be removed from the deck. The footboard further includes a tool-receiving device coupled to the latch mechanism and configured to receive a tool therein in order to move the latch mechanism from the locked position to the unlocked position.

### CROSS-REFERENCE TO RELATED APPLICATIONS

This application claims priority to U.S. Provisional Application Ser. No. 61/369,466, filed Jul. 30, 2010, which is incorporated by reference herein in its entirety

### BACKGROUND

The present disclosure relates to a patient support apparatus, such as a hospital bed, for supporting a patient, and particularly to a chair bed that can be manipulated to achieve both a conventional bed position having a horizontal sleeping surface upon which a person lies in a supine position and a sitting, or chair egress, position having the feet of the person on or adjacent to the floor and the head and back of the person supported above a seat formed by the bed. More particularly, the present disclosure relates to a footboard of the chair bed which is removable when the bed is moved to the sitting, or chair egress, position.

### SUMMARY

The present application discloses one or more of the features recited in the appended claims and/or the following features which, alone or in any combination, may comprise patentable subject matter.

According to one aspect of the present disclosure, a patient support apparatus includes a deck configured to support a mattress assembly thereon, and a footboard removably coupled to the deck. Illustratively, the footboard includes a latch mechanism movable between a locked position wherein the latch mechanism is engaged with the deck to prevent the footboard from being removed from the deck and an unlocked position wherein the latch mechanism is disengaged from the deck to allow the footboard to be removed from the deck. The footboard further includes a tool-receiving device coupled to the latch mechanism and configured to receive a tool therein in order to move the latch mechanism from the locked position to the unlocked position.

In one illustrative embodiment, the latch mechanism may be coupled to a rear surface of the footboard.

In another illustrative embodiment, the latch mechanism may include a first latch pivotably coupled to a main body of the footboard. Illustratively, the first latch may be pivotable about an axis of rotation parallel to a width of the deck. Further illustratively, the latch mechanism may include a second latch spaced-apart from the first latch and pivotably coupled to the main body of the footboard. The first and second latches may be coupled to each other such that movement of one of the first and second latches operates to generally simultaneously move the other of the first and second latches. The first latch may be positioned adjacent to the tool-receiving device.

In still another illustrative embodiment, the tool-receiving device may include a slot configured to receive a generally thin object therein. Illustratively, the slot may be configured to receive a coin therein. Alternatively, the slot may be configured to receive a caregiver ID card therein. The latch mechanism may include a lever configured to be engaged and moved by the generally thin object.

In yet another illustrative embodiment, the tool-receiving device may be configured to receive a cylindrical object therein. Illustratively, the tool-receiving device may be configured to prevent a portion of a caregiver's body to be received therein.

In still another illustrative embodiment, the latch mechanism may be spring-biased to the locked position.

In another illustrative embodiment, the tool-receiving device may be a solenoid in electrical communication with a user input device.

In yet another illustrative embodiment, the footboard may further include a first post coupled to and configured to extend away from a rear surface of a main body of the footboard. Illustratively, the deck may include a post-receiving receptacle and the post of the footboard may be removably received within the post-receiving receptacle when the footboard is coupled to the deck. Further illustratively, the post-receiving receptacle may be positioned under a mattress support surface of the deck. A longitudinal axis of the post may be parallel to a plane of a foot section of the deck when the footboard is coupled to the deck. The footboard may also include a second post spaced-apart from the first post, wherein the second post is coupled to and configured to extend away from the rear surface of the main body of the footboard. The latch mechanism may be positioned between the first and second posts.

According to another aspect of the present disclosure, a footboard configured to be removably coupled to a patient support apparatus, such as hospital bed, includes a main body defining a plane and a post coupled to a rear surface of the main body and extending away from the main body in a direction perpendicular to the plane of the main body. Illustratively, the post is configured to be coupled to the patient support apparatus. The footboard also includes a latch mechanism coupled to a rear surface of the main body. The latch mechanism is movable between (i) a locked position wherein the latch mechanism is configured to be engaged with a portion of the patient support apparatus in order to prevent the footboard from being removed from the patient support apparatus, and (ii) an unlocked position wherein the latch mechanism is configured to be disengaged from the portion of the patient support apparatus in order to allow the footboard to be removed from the patient support apparatus.

In one illustrative embodiment, the footboard may further include a tool-receiving device coupled to the main body of the footboard. Illustratively, the tool-receiving device may include at least one of a slot and an aperture adjacent the latch mechanism such that receipt of a coordinating tool into one of the slot and the aperture may operate to engage the latch mechanism and move the latch mechanism from the locked position to the unlocked position. The tool-receiving device may be coupled to a front surface of the main body of the footboard.

In another illustrative embodiment, the latch mechanism may be pivotable about an axis perpendicular to a longitudinal axis of the post.

In still another illustrative embodiment, the post may be a first post and the footboard may further include a second post coupled to the rear surface of the main body and extending away from the main body in a direction perpendicular to the plane of the main body. Illustratively, the second post may be spaced-apart from the first post and may also be configured to be coupled to the patient support apparatus. The latch mechanism may be positioned between the first and second posts.

In yet another illustrative embodiment, the rear surface of the footboard may include a cut-out portion defining a cut-out space. Illustratively, the latch mechanism may be positioned within the cut-out space.

According to yet another aspect of the present disclosure, a footboard configured to be removably coupled to a patient support apparatus, such as hospital bed, includes a main body defining a plane and a post coupled to a rear surface of the main body and extending away from the main body in a direction perpendicular to the plane of the main body. Illustratively, the post is configured to be coupled to a deck section of the patient support apparatus. Further illustratively, the footboard is removed from the deck section of the patient support apparatus in a direction perpendicular to the plane of the main body and parallel to a plane of the deck section to which the footboard is configured to be coupled.

Additional features, which alone or in combination with any other feature(s), such as those listed above, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures, in which:

FIG. 1 is a perspective view of a chair bed showing the chair bed in a bed position and including a footboard coupled to a foot end of a deck of the chair bed;

FIG. 2 is a perspective view of the chair bed of FIG. 1 showing the chair bed in the sitting position with the footboard removed therefrom;

FIG. 3 is a front perspective view of the footboard of the chair bed of FIGS. 1 and 2;

FIG. 4 is a rear perspective view of the footboard;

FIG. 5 is a front view of the footboard;

FIG. 6 is a rear view of the footboard;

FIG. 7 is a side view of the footboard; and

FIG. 8 is a front perspective view of the footboard coupled to a foot section of the deck of the chair bed.

### DETAILED DESCRIPTION

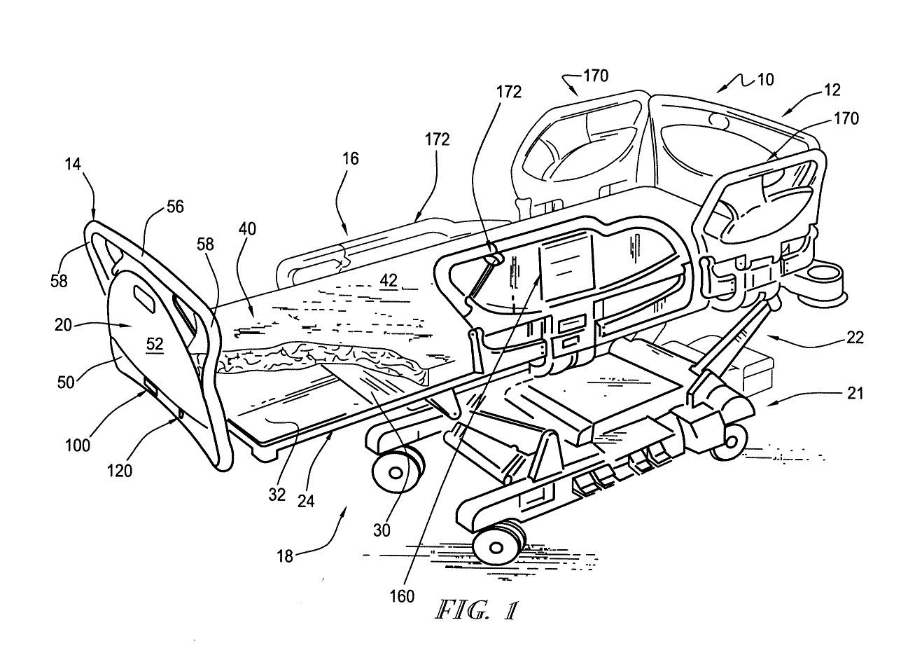

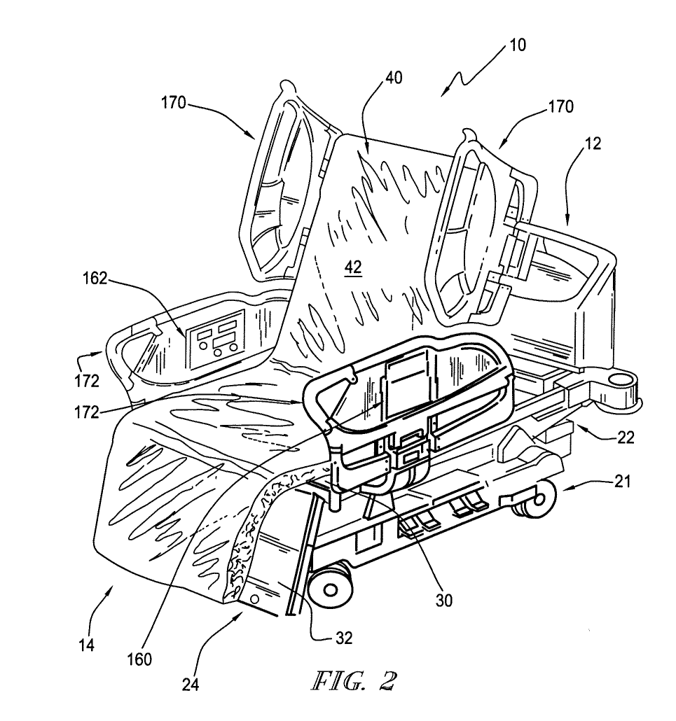

A chair bed 10 of the present disclosure includes a head end 12, a foot end 14, and sides 16, 18. The chair bed 10 is able to move between a conventional bed position, as shown in FIG. 1, and a sitting, or chair egress, position, as shown in FIG. 2. As is discussed in greater detail below, a footboard 20 of the bed 10 is removed from the bed 10 when the bed 10 is moved to the chair egress position. Removal of the footboard 20 from the bed 10 is accomplished through the use of an extracorporeal tool or accessory. It should be understood that while the particular chair bed 10 is shown in FIGS. 1 and 2, the removable footboard 20 of the present disclosure may be used with any suitable patient support apparatus including any suitable hospital bed, chair bed, or the like.

Looking now to FIGS. 1 and 2, the chair bed 10 includes a base frame 21, an intermediate frame 22 coupled to the base frame 21, and an articulating deck 24 coupled to the intermediate frame 22. Illustratively, the articulating deck 24 includes a longitudinally-spaced head section (not shown), seat section (not shown), thigh section 30, and foot section 32. The head, thigh, and foot sections 30, 32 are movable relative to each other and are movable relative to the seat section. The head, thigh, and foot sections 30, 32 are infinitely adjustable to allow the bed 10 to attain any desired position within the range of movement of the head, thigh, and foot sections 30, 32, thus accommodating changes of position of a person on the bed 10. Of course, the articulating deck 24 can provide a planar, horizontal sleeping surface (as shown in FIG. 1), a planar sleeping surface that is tilted toward either the head end of the bed or the foot end of the bed 10, and a non-planar chair-shaped seating surface (when the chair bed 10 is in the chair egress position shown in FIG. 2), in addition to any number of intermediate positions therebetween. In the sitting position, the head end 12 of the head section of the deck 24 is pivoted upwardly away from the intermediate frame 22 to a back-support position providing a pivotable backrest so that the head section and intermediate frame 22 form an angle. The seat section 28 of the deck 24 is positioned to lie generally horizontally as in the initial position, the foot end 14 of the thigh section 30 is slightly upwardly inclined, and the foot section 32 of the deck 24 extends generally vertically downwardly from the thigh section 30. As noted above, the footboard 20 is removed fro the bed 10 when the bed 10 is in the chair egress position. In particular, the footboard 20 is removed from the bed 10 through the use of a tool, and may otherwise not be removed from the bed 10 by a caregiver.

Illustratively, the bed 10 also includes a mattress assembly 40 configured to rest upon a mattress support surface of the articulating deck 24 of the bed 10. Thus, in the conventional bed position, shown in FIG. 1, a horizontal sleeping surface 42 of the mattress assembly 40 is configured to support a person lying in a supine position. When the chair bed 10 is moved to the sitting, or chair egress position, shown in FIG. 2, the feet of the person on the mattress assembly 40 are located on or adjacent to the floor and the head and back of the person are supported above a seat formed by the bed 10. The bed 10 may also include a mechanism for raising and lowering the articulating deck and the sleeping surface between a low position and a raised position relative to the base of the bed. In addition, the bed may also include mechanisms for independently raising and lowering each of the head section 26, the thigh section 30, and the foot section 32 so that the bed 10 can assume many positions to suite the specific needs of individuals.

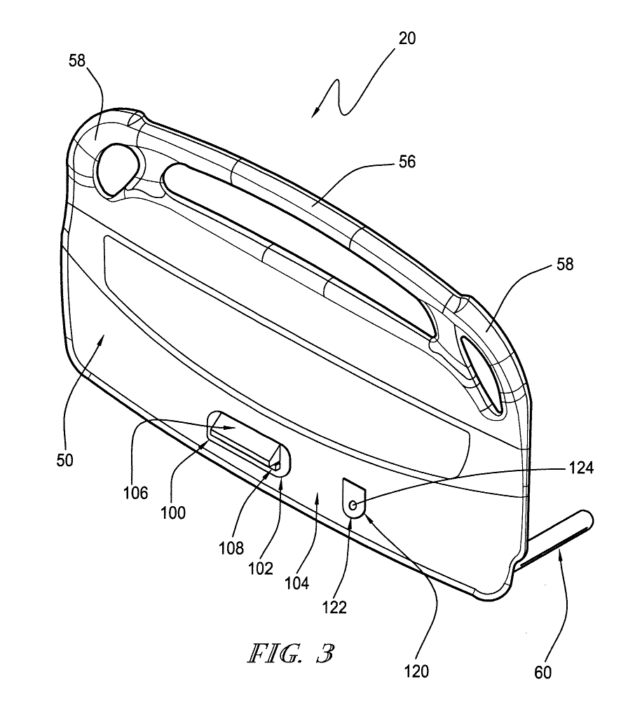

As discussed above, the chair bed 10 includes the footboard 20, shown in detail in FIGS. 3-8. While the particular chair bed 10 is shown and described herein, it should be understood that the footboard 20 of the present disclosure may be used with any suitable patient support apparatus. Illustratively, the footboard 20 is removably coupled to the deck 24 of the bed 10. In particular, the footboard 20 is coupled to the foot section 32 of the deck 24 of the bed 10 when the bed 10 is in any conventional bed position whereby the deck sections are planar or articulated relative to each other. In use, when the bed 10 is moved to the chair egress position, shown in FIG. 2, the footboard 20 is removed from the deck 24 of the bed 10. In particular, the footboard 20 may be removed by a caregiver prior to moving the bed 10 to the chair egress position. Alternatively, the footboard 20 may be removed by a caregiver when the bed 10 has been partially moved to the chair egress position. Once the chair egress position of the bed 10 is no longer needed, the caregiver may operate the bed 10 to move the bed 10 to any one of a number of conventional bed positions. At this time, the footboard 20 may again be coupled to the deck 24 of the bed 10. Illustratively, as is discussed in greater detail below, a tool is used to unlock the footboard 20 from the foot section 32 of the deck 24 of the bed 10 to allow the caregiver to then remove the footboard 20 therefrom. Illustratively, a tool may be any extracorporeal device, typically, but not necessarily, a handheld device, that is not part of a caregiver's own self or body. In other words, a tool does not include the caregiver's own hands, arms, feet, etc., but may include any device held or engaged by the caregiver and used by the caregiver to unlock the footboard 20 from the deck 24 of the bed 10. Without the use of this tool, the footboard 20 remains in a locked position on the deck 24 of the bed 10 and cannot be removed by the caregiver. Accordingly, the footboard 20 is a tool-removable footboard in that an extracorporeal tool is required in order to allow a caregiver to remove the footboard 20 from the deck 24 of the bed 10.

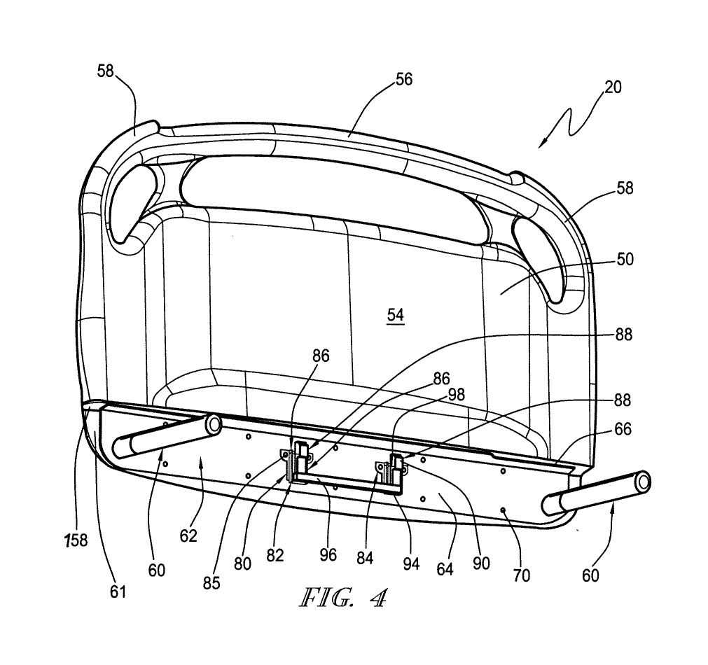

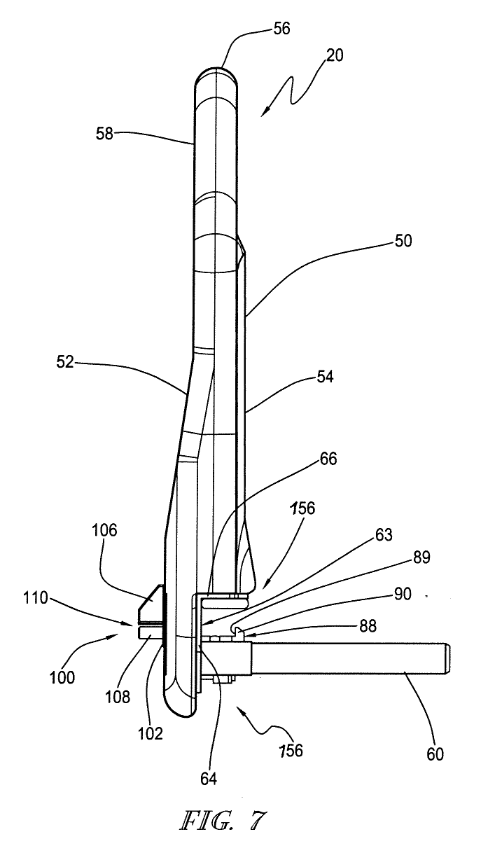

Looking now to FIGS. 3-8, the footboard 20 includes a main body 50 having a front surface 52 and a rear surface 54. Illustratively, the main body 50 includes an upper, central handle 56 and two side handles 58. While the illustrative footboard 20 includes the particular main body 50 shown in FIGS. 3-8, it should be understood that other suitable footboards having other suitable shapes and sizes may be used as well. The footboard 20 further includes two posts 60 coupled to and configured to extend away from the main body 50, as shown in FIGS. 4 and 7. Illustratively, the posts 60 are coupled to a bracket 62 of the footboard 20 that is coupled to the rear side of the main body 50. In particular, the bracket 62 is coupled to a cut-out portion 156 of the main body 50, as shown in FIG. 7. The cut-out portion 156 is formed in a bottom portion of the rear surface 54 of the main body 50 to define an upper surface 158 and a rear surface 61 of the cut-out portion 156. The cut-out portion 156 of the footboard 20 further defines a cut-out space or area 63 of the footboard 20. Illustratively, the bracket 62 includes a main panel 64 adjacent to and generally flush with the rear surface 61 and an upper flange 66 adjacent to and generally flush with the upper surface 158. The illustrative bracket 62 is coupled to the main body 50 with mechanical fasteners 70 such as screws, bolts, rivets, or nails, for example. It is also within the scope of this disclosure for the bracket 62 to be coupled to the main body 50 of the footboard 20 using other suitable fastening means such as adhesives, welds, etc.

The posts 60 of the footboard 20 are coupled to and extend away from the main panel 64 of the bracket 62. In particular, the longitudinal axis of each post 60 is generally perpendicular to a plane defined by the main panel 64 of the bracket 62, as shown in FIG. 7. Further illustratively, the longitudinal axis of each post 60 is perpendicular to a plane defined by the main body 50 of the footboard 20. As is discussed in greater detail below, the posts 60 of the footboard 20 are configured to be coupled to the deck 24 of the bed 10. Illustratively, the posts 60 are spaced-apart from each other such that each post 60 is located at one of the right and left sides of the main panel 64 of the footboard 20. The posts 60 are generally cylindrical in shape such that a cross-section of each post 60 is generally circular in shape. It should be understood, however, that the posts 60 may define other suitable cross-sectional shapes as well. It should further be understood that while the illustrative footboard 20 includes two posts 60, the footboard may include any suitable number of posts configured to be coupled to the deck 24 of the bed 10.

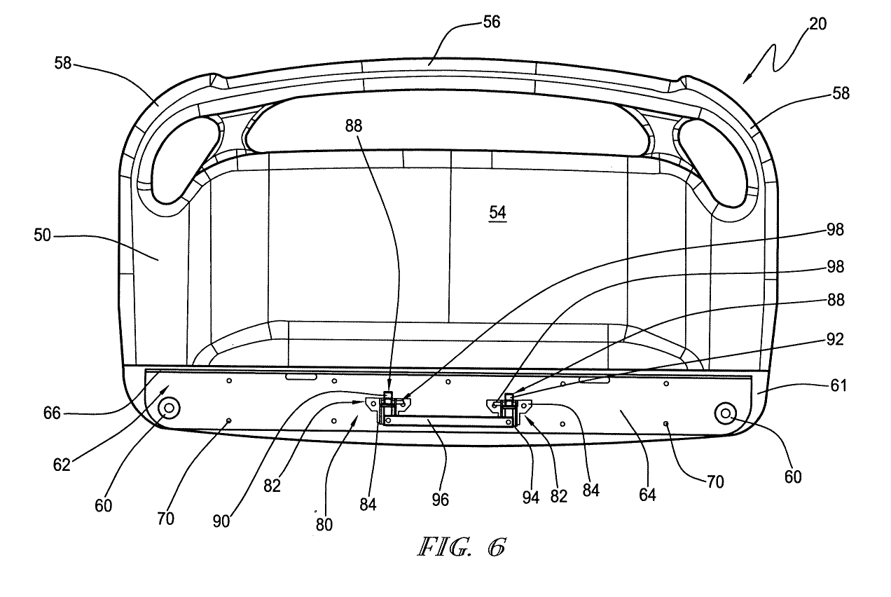

The footboard 20 also includes a latch mechanism 80, shown best in FIGS. 4 and 6. As is discussed in greater detail below, the latch mechanism 80 operates to removably couple the footboard 20 to the deck 24 of the bed 10 by removably coupling with associated structure of the foot section 32 of the deck 24 of the bed 10. In particular, the latch mechanism 80 is movable between a locked position wherein the latch mechanism is engaged with the deck 24 to prevent the footboard 20 from being removed from the deck 24, and an unlocked position wherein the latch mechanism 80 is disengaged from the deck 24 to allow the footboard 20 to be removed from the deck 24. Illustratively, the latch mechanism 80 is coupled to the main panel 64 of the bracket 62 of the footboard 20 and is positioned between the two posts 60 of the footboard 20. Further illustratively, the latch mechanism 80 is generally positioned within the cut-out space 63 of the footboard 20, as shown in FIG. 7. While the illustrative footboard 20 is coupled to the deck 24 of the bed 10, it should be understood that the footboard 20 may be coupled to any other suitable structure of the bed 10 located generally at or near the foot end 14 of the bed 10.

Looking now to FIGS. 4 and 6, the latch mechanism 80 includes first and second supports 82 spaced-apart from each other and coupled to the main panel 64 of the bracket 62. Illustratively, each support 82 includes a rear panel 84 that is coupled to and generally flush with the main panel 64 of the bracket 62. A fastener 85, such as a screw, rivet, bolt, or nail is used to couple each rear panel 84 of the latch mechanism 80 to the main panel 64 of the bracket 62. Other suitable fasteners or fastening means, such as welds and/or adhesives may be used as well. Each support 82 also includes a pair of spaced-apart flanges 86 coupled to the respective rear panel 84. Illustratively, the flanges 86 of each support 82 extend away from the rear panel 84 and define a latch-receiving space therebetween.

The latch mechanism 80 further includes a latch 88 positioned within the latch-receiving space of each support 82 and pivotably coupled to the spaced-apart flanges 86 of each support 82. As such, the latch mechanism 80 includes two latches 88 which are each configured to couple with a coordinating structure (not shown) of the foot section 32 of the deck 24 of the bed 10 in order to couple and lock the footboard 20 to the deck 24 of the bed 10. Illustratively, each latch 88 includes a head portion 90 configured to engage with the coordinating structure of the foot section 32 of the deck 24, a body portion 92 coupled to the head portion 90, and a foot portion 94 coupled to and extending downwardly from the body portion 92. The body portion 92 of each latch 88 is pivotably coupled to the pair of spaced-apart flanges 86 of the respective support 82 to which each latch 88 is coupled. Illustratively, a bar 96 of the latch mechanism 80 is coupled to and extends between the foot portion 94 of each latch 88. As is discussed in greater detail below, the bar 96 operates to coordinate the movement of the latches 88 with each other such that the latches 88 move generally simultaneously with each other. As such, movement of one latch 88 causes the other latch 88 to move therewith.

As shown in FIG. 4, a pivot pin 98 is received through the body portion 92 of each latch 88 and the spaced-apart flanges 86 on either side of the body portion 92 of each latch 88 in order to pivotably couple the latch 88 to the respective support 82. Accordingly, in use, each latch 88 is pivotable relative to the support 82 to which it is coupled about an axis through the pin 98. Illustratively, the axis of rotation of each pin 98 is generally parallel a width of the deck 24. Each latch 88 is movable between a locked position, shown in FIGS. 4, 6, and 7, and an unlocked position (not shown) in which the head portion 90 of each latch 88 is pivoted rearwardly about the pivot pin 98. As is discussed in greater detail below, the latches 88 are configured to engage the coordinating structure of the foot section 32 of the deck 24 of the bed 10 when in the locked position in order to secure the footboard 20 to the deck 24 of the bed 10. Illustratively, when the latches 88 are in the locked position, the footboard 20 is also in a locked position on the deck 24 of the bed 10 and is not able to be removed from the deck 24 of the bed 10 without moving the latches 88 to the unlocked position. Further illustratively, when the latches 88 are in the unlocked position, the latches 88 are disengaged from the coordinating structure of the deck 24 of the bed 10 thus allowing the footboard 20 to be removed from the deck 24 of the bed 10.

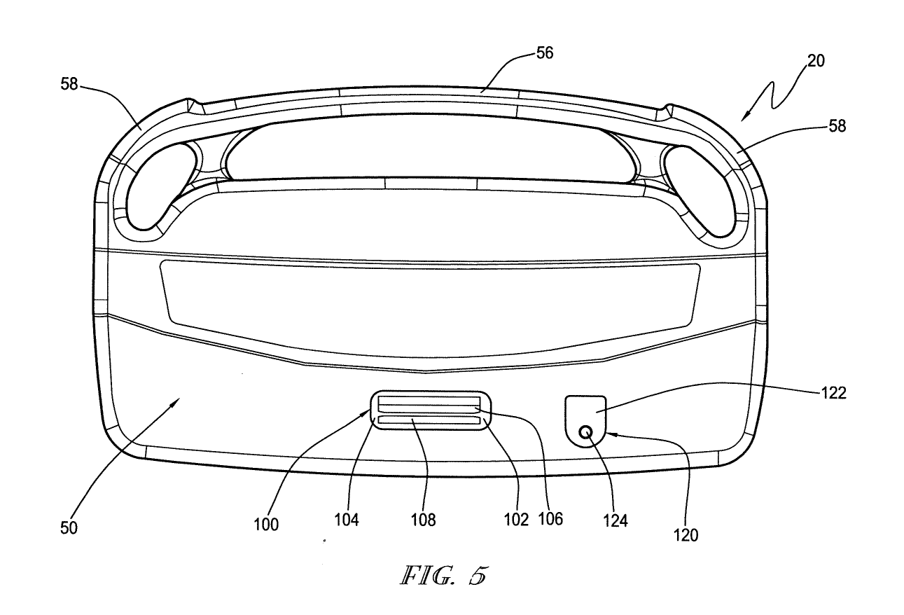

Looking now to FIG. 5, the footboard 20 further includes a card-receiving receptacle 100 coupled to the main body 50 of the footboard 20. Illustratively, the card-receiving receptacle 100 includes a generally oval-shaped body 102 received within an aperture 104 formed in the front surface 52 of the main body 50 of the footboard 20, an upper protrusion 106 coupled to the body 102 and configured to extend outwardly therefrom, and a lower protrusion 108 coupled to the body 102 and configured to extend outwardly therefrom. Illustratively, the upper and lower protrusions 106, 108 are spaced-apart from each other to define a card-receiving slot 110 therebetween. Illustratively, the upper protrusion 106 is imprinted with the words “SLIDE CARD TO RELEASE FOOT BOARD” in order to instruct a caregiver to slide a card, such as a caregiver ID card, for example, within the card-receiving slot 110 in order to release, or unlock, the latch mechanism 80 and thus the footboard 20 such that the footboard 20 may be removed by the caregiver from the deck 24 of the bed 10. Illustratively, the card-receiving receptacle 100 operates as a tool-receiving device of the footboard 20. As is discussed in greater detail below, such a tool-receiving device provides an input area, such as the slot 110, for receiving a tool (not shown) therein. As noted above, such a tool includes any device or accessory that may be used by a caregiver, but not including any portion of the caregiver's own body, to move the latch mechanism 80 to an unlocked position. In particular, the tool configured for use with the card-receiving receptacle 100 is the caregiver's ID card, or any similarly sized and shaped card or device having a portion able to be received within the slot 110 of the receptacle 100.

Looking still to FIG. 5, the footboard 20 includes another illustrative tool-receiving device. In particular, the footboard 20 includes a pen-receiving receptacle 120 including a body 122 coupled to the front surface 52 of the footboard 20. The body includes an aperture 124 formed therethrough. Illustratively, the aperture 124 is sized and configured to receive a pen (not shown) and/or a tip of a pen therein. As such, the body 122 is illustratively imprinted with the words “INSERT PEN” in order to instruct a caregiver to insert a pen into the aperture 124 in order to release, or unlock, the footboard 20 from the deck 24 to allow a caregiver to remove the footboard 20 from the deck. As such, the tool provided for use with the pen-receiving receptacle 120 is a pen, or any other similarly sized and shaped device having a generally cylindrical portion able to be received within the aperture 124 of the receptacle 120. As is discussed in greater detail below, the two tool-receiving receptacles 100, 120 of the footboard 20 provide access to a portion of the latch mechanism 80 such that a coordinating tool inserted into at least a portion of each of the receptacles 100, 120 is able to engage a portion of the latch mechanism 80 to move the latch mechanism 80 to the unlocked position.

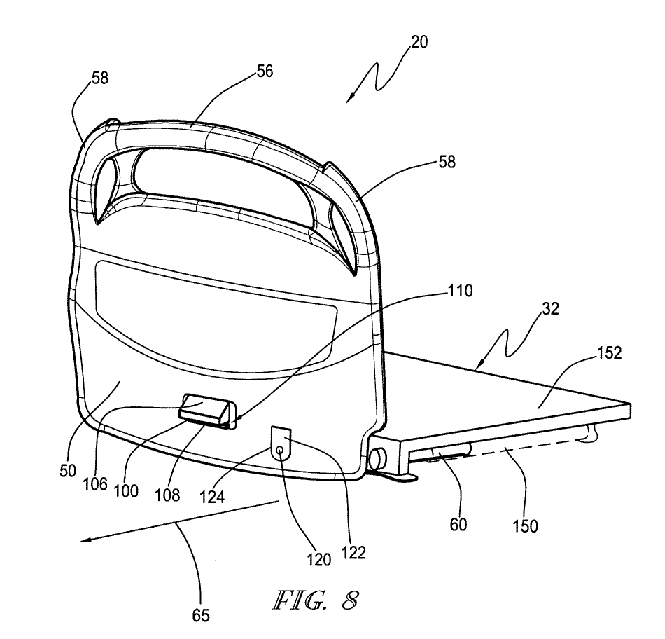

In use, the footboard 20 is coupled to the deck 24 of the bed 10 when the bed 10 is positioned in any of a number of conventional bed positions, such as the supine position shown in FIG. 1, for example. As shown in FIG. 8, the posts 60 of the footboard 20 are received within post-receiving receptacles 150 of the foot section 32 of the deck 24 in order to couple the footboard 20 to the deck 24. Illustratively, the post-receiving receptacles 150 are positioned below a foot plate 152 of the foot section 32 of the deck 24. Each post-receiving receptacle 150 is generally cylindrical in shape in order to accommodate the generally cylindrical shape of the posts 60. Of course, it should be understood that the post-receiving receptacles 150 may be any shape and size to accommodate and coordinate with posts of the footboard having other shapes and sizes. Illustratively, the post-receiving receptacles 150 each define a longitudinal axis that is generally parallel to a longitudinal axis of the bed 10 itself. In other words, the post-receiving receptacles 150 run along a length of the bed 10. More particularly, the longitudinal axis of each post-receiving receptacle 150 is parallel to a plane defined by the plate 152 of the foot section 32 of the deck 24. In use, the posts 60 may be removed and inserted into the post-receiving receptacles 150 when the bed 10 is in any number of positions. As such, insertion of the posts 60 into and removal of the posts 60 from the post-receiving receptacles 150 is done along an axis that is parallel to the plane of the foot section 32 of the deck 24 in order to allow a caregiver to slide the footboard 20 off the deck 24 by moving the footboard 20 in a direction 65 (shown in FIG. 8) that is away from the deck 24 and generally parallel to the foot section 32 of the deck 24.

When the posts 60 are positioned within the respective post-receiving receptacles 150, the latch mechanism 80 is normally engaged with the coordinating structure (not shown) of the foot section 32 of the deck 24 such that the footboard 20 is in a locked position with respect to the deck 24. In particular, when the latch mechanism 80 is in the locked position, the head portion 90 of each latch 88 are engaged with the coordinating structure of the foot section 32 of the deck 24. For example, the head portion 90 of each latch 88 may be received within a slot or aperture of the foot section 32 of the deck 24 such that a rearward surface 89 of each latch 88 (as shown in FIG. 7) is configured to engage a portion of the foot section 32 in order to prevent a caregiver from pulling the footboard 20 in a direction away from the foot section 32 and removing the footboard 20 from the deck 24. It should be understood, however, that the foot section 32 of the deck 24 may include other suitable structure(s) configured to be coupled to the latches 88 of the latch mechanism 80 in order to prevent a caregiver from removing the footboard 20 from the deck 24 when the latch mechanism 80 is in the locked position. Although not shown, the latches 88 may be spring-biased to the locked position.

In order to remove the footboard 20 from the foot section 32 of the deck 24, the caregiver must move the latch mechanism 80 from the normally locked position to the unlocked position. As noted above, this may be accomplished through the use of two different tool-receivable receptacles 100, 120 configured to receive a particular tool therein. Illustratively, the first tool-receivable device is the card-receiving receptacle 100. To use the card-receivable receptacle 100, the caregiver simply slides a card, such as their caregiver ID badge, a credit card, or other similarly-sized card through the card-receiving slot 110 of the receptacle 100. In use, the caregiver's card engages and moves a lever (not shown) coupled to and/or located within the main body 50 of the footboard 20. Illustratively, this lever is coupled to one of the two latches 88 of the latch mechanism 80 and forms part of the latch mechanism 80. As such, movement of the lever per the caregiver's card operates to move one of the two latches 88 from the normally upright, locked position to the unlocked position. In other words, movement of the lever operates to pivot one of the two latches 88 rearwardly about the pivot pin 98.

As noted above, the latch mechanism 80 includes the bar 96 coupling the foot portion 94 of each latch 88 together. Thus, movement of one of the latches 88 to the unlocked position operates to simultaneously move the other latch 88 to the unlocked position as well. Illustratively, while the caregiver's card is described as engaging a lever of the latch mechanism 80, it should be understood that the latch mechanism may include any other suitable structure which may be engaged by the caregiver's card in order move one of the latches 88 to the unlocked position. Such structure may be directly coupled to one of the latches 88 or may be indirectly coupled to one of the latches 88 via a number of other movable structures, such as linkages, for example. It should also be understood that the caregiver's card may directly engage a portion of one of the latches 88 in order to move the latch 88 to the unlocked position.

Once both latches 88 are moved to the unlocked position, the caregiver is able to pull on the footboard 20 to slide the posts 60 of the footboard 20 out of the post-receiving receptacles 150 of the foot section 32 of the deck 24 in order to remove the footboard 20 from the deck 24 of the bed 10. As noted above, the footboard 20 is removed from the deck 24 by sliding the footboard 20 in a direction 65 away from the deck 24 and parallel to a plane defined by the foot section 32 of the deck 24. Once the footboard 20 is fully removed from the deck 24, the bed 10 may be moved to the chair egress position shown in FIG. 2. In order to couple the footboard 20 back onto the deck 24, the caregiver simply inserts each post 60 into the respective post-receiving receptacle 150 and moves the main body 50 of the footboard 20 in a direction toward the deck 24 until the latches 88 of the latch mechanism 80 are properly engaged with the coordinating structure of the foot section 32 of the deck 24 and the footboard 20 is again in the locked position on the deck 24.

As noted above, the footboard 20 includes yet another tool-receivable device. In particular, the footboard 20 includes the pen-receiving receptacle 120. In order to remove the footboard 20 from the deck section 24 of the bed 10, a user may insert a pen or another similarly sized and shaped long, cylindrical device into the aperture 124 of the receptacle 120. Similar to that described above in regard to use of the card-receiving receptacle 100, the caregiver's pen operates to engage and move the lever coupled to and/or located within the main body 50 of the footboard 20. As noted above, this lever is coupled to one of the two latches 88 of the latch mechanism 80 such that movement of the lever per the caregiver's pen operates to move one of the two latches 88 from the normally upright, locked position to the unlocked position. Movement of one of the latches 88 operates to simultaneously move the other latch 88 as well such that both latches 88 are moved to the unlocked position.

Illustratively, while the caregiver's pen is described as engaging a lever of the latch mechanism 80, it should be understood that the latch mechanism 80 may include any other suitable structure which may be engaged by the caregiver's pen in order move one of the latches 88 to the unlocked position. Such structure may be directly coupled to one of the latches 88 or may be coupled to one of the latches 88 via a number of other movable structures, such as linkages, for example. It should also be understood that the caregiver's pen may directly engage a portion of one of the latches 88 in order to move the latch 88 to the unlocked position. Further, the latch mechanism 80 may be configured such that the caregiver's pen engages the same structure that the caregiver's card engages when the card is slid through the card-receiving receptacle 100. Alternatively, the latch mechanism 80 may be configured such that the caregiver's pen engages a structure different from that which is engaged by the caregiver's card. Regardless, both the caregiver's card and the caregiver's pen operate as tools used to engage a lever or other such structure capable of moving one of the latches 88 to the unlocked position.

Illustratively, while the caregiver's card and the caregiver's pen are discussed above as tools receivable within, or engagable with, the two tool-receivable receptacles 100, 120 of the footboard 20, it should be understood that other tools may be used with each of the tool-receivable receptacles 100, 120 as well. In particular, any device, or tool, which has at least a portion that is thin enough to be received within the card-receiving slot of the receptacle 100 may be used with the receptacle 100 in order to move the latches 88 of the latch mechanism 80 to the unlocked position. Similarly, any device, or tool, which includes at least a portion that is able to fit within the aperture 124 of the receptacles 120 may be used with the receptacle 120 in order to move the latches 88 of the latch mechanism 80 to the unlocked position. Furthermore, it should be understood that while the footboard 20 includes the particular tool-receivable receptacles 100, 120 described above, the footboard 20 may include different or other tool-receivable devices as well which similarly operate to allow a user to use a tool to move the latches 88 of the latch mechanism 80 to the unlocked position.

For example, in another embodiment, the footboard 20 may be configured to include a coin-receiving slot (not shown) configured to receive a coin, such as a quarter, dime, nickel, penny, or other similarly-sized object at least partially therein. In use, the coin, once inserted into the slot, may be turned approximately 90 degrees in order to rotate a latch or lever 90 degrees therewith. Rotating the latch or lever would similarly operate to either directly or indirectly engage at least one of the latches 88 of the latch mechanism 80 in order to move the latches 88 to the unlocked position.

In still another embodiment, a graphical user interface 160 (shown in FIGS. 1 and 2) may be used by a caregiver to unlock the footboard 20 from the deck 24 of the bed 10. Illustratively, the bed 10 includes two head section side rails 170 and two seat section side rails 172. Each seat section side rail 172 includes the graphical user interface 160 coupled to an outside portion of the side rail 172. Illustratively, another user interface, or control panel, 162 having various buttons and display screens is coupled to an inside portion of each side rail 172, as shown in FIG. 2. Illustratively, either the graphical user interface 160 and/or user interface 162 may be used to unlock the footboard 20 from the deck 24 of the bed 10. In use, therefore, the caregiver may enter a code and/or instruction into either the graphical user interface 160 and/or the user interface 162. Upon entering such an instruction, the graphical user interface 160 and/or the user interface 160 may send an electronic unlock signal to a device coupled to one of the latches 88 of the latch mechanism 80 in order to move the latches 88 to the unlocked position. For example, the unlock signal may operate to move a solenoid that is coupled (either directly or indirectly) to at least one of the latches 88. In turn, the movement of the solenoid may operate to move at least one of the latches 88 to the unlocked position. In use, the unlock signal may operate to maintain the solenoid in the unlocked position for a predetermined period of time before moving the solenoid, and thus the latches 88, back to the locked position.

Illustratively, in all embodiments shown and/or described above, the footboard 20 is a tool-removable footboard in that a tool is required in order to allow a caregiver to remove the footboard 20 from the deck 24 of the bed 10. Without the use of this tool, the footboard 20 remains in a locked position on the deck 24 of the bed 10 and cannot be removed by the caregiver. Illustratively, the tool may be a card, a pen, a coin, or other similarly sized and shaped structures. Furthermore, the tool may also be a user interface, such as the \user interfaces 160, 162 described above. It should be understood that while various tools are described for use with the footboard 20, the footboard 20 may be configured to include other suitable tool-receiving devices for use with other suitable tools. In particular, the footboard 20 of the present disclosure may include a tool-receiving device having an aperture formed therein that is specifically sized and configured for a particular tool to be received therethrough in order to engage a portion of the latch mechanism 80 to move at least one of the latches 88 from the locked position to the unlocked position. Furthermore, other electronic devices may be coupled to the latch mechanism 80 to allow a user to provide instructions and send a signal through a control system to move the latch mechanism 80 to the unlocked position.

Further illustratively, while the particular latch mechanism 80 is shown and described above, it is within the scope of this disclosure for the footboard 20 to include any other suitable latch mechanism configured to engage a portion of the bed 10 in a locked position and to disengage a portion of the bed in an unlocked position. Such other latch mechanisms may include one or more latches, levers, or other such structures which are received within or engaged with a coordinating structure of the bed 10 when the latch mechanism is in the locked position in order to prevent a caregiver from removing the footboard 20 from the deck 24 of the bed 10. Such other latch mechanisms may also include any suitable latch which is movable (linearly and/or pivotably) to selectively engage and disengage the coordinating structure of the deck 24 of the bed.

Finally, as noted above, any such suitable latch mechanism of the footboard 20 may include a movable structure adjacent the tool-receiving device of the footboard 20 and generally accessible through an aperture or slot of the tool-receiving device of the footboard 20 in order to allow a tool to move the latch mechanism to an unlocked position. In other words, the tool-receivable device provides access (such as through an opening) to the latch mechanism to allow the coordinating tool to engage the latch mechanism and move the latch mechanism to the unlocked position. Alternatively, the latch mechanism may be in electrical communication with a tool-receiving device, such as a solenoid, for example, which receives an electrical signal providing instructions to move the latch mechanism. In particular, each of the illustrative user interfaces 160, 162 described above may be considered as a tool while the solenoid, or other such device which acts upon the latch mechanism, may be considered as the tool-receiving device in that the solenoid receives a signal, i.e., the unlock signal, from one of the user interfaces 160, 162.

Although certain illustrative embodiments have been described in detail above, variations and modifications exist within the scope and spirit of this disclosure as described and as defined in the following claims. Further, while the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

1. A patient support apparatus comprising:
a deck configured to support a mattress assembly thereon; and
a footboard removably coupled to the deck, wherein the footboard includes (i) a latch mechanism movable between a locked position wherein the latch mechanism is engaged with the deck to prevent the footboard from being removed from the deck and an unlocked position wherein the latch mechanism is disengaged from the deck to allow the footboard to be removed from the deck, and (ii) a tool-receiving device coupled to the latch mechanism and configured to receive a tool therein in order to move the latch mechanism from the locked position to the unlocked position.

2. The patient support apparatus of claim 1, wherein the latch mechanism is coupled to a rear surface of the footboard.

3. The patient support apparatus of claim 1, wherein the latch mechanism includes a first latch pivotably coupled to a main body of the footboard.

4. The patient support apparatus of claim 3, wherein the first latch is pivotable about an axis of rotation parallel to a width of the deck.

5. The patient support apparatus of claim 3, wherein the latch mechanism includes a second latch spaced-apart from the first latch and pivotably coupled to the main body of the footboard.

6. The patient support apparatus of claim 5, wherein the first and second latches are coupled to each other such that movement of one of the first and second latches operates to generally simultaneously move the other of the first and second latches.

7. The patient support apparatus of claim 3, wherein the first latch is positioned adjacent to the tool-receiving device.

8. The patient support apparatus of claim 1, wherein the tool-receiving device includes a slot configured to receive a generally thin object therein.

9. The patient support apparatus of claim 8, wherein the slot is configured to receive a coin therein.

10. The patient support apparatus of claim 8, wherein the slot is configured to receive a caregiver ID card therein.

11. The patient support apparatus of claim 8, wherein the latch mechanism includes a lever configured to be engaged and moved by the generally thin object.

12. The patient support apparatus of claim 1, wherein the tool-receiving device is configured to receive a cylindrical object therein.

13. The patient support apparatus of claim 1, wherein the tool-receiving device is configured to prevent a portion of a caregiver's body to be received therein.

14. The patient support apparatus of claim 1, wherein the latch mechanism is spring-biased to the locked position.

15. The patient support apparatus of claim 1, wherein the tool-receiving device is a solenoid in electrical communication with a user input device.

16. The patient support apparatus of claim 1, wherein the footboard further includes a first post coupled to and configured to extend away from a rear surface of a main body of the footboard.

17. The patient support apparatus of claim 16, wherein the footboard includes a second post spaced-apart from the first post, wherein the second post is coupled to and configured to extend away from the rear surface of the main body of the footboard.

18. The patient support apparatus of claim 17, wherein the latch mechanism is positioned between the first and second posts.

19. The patient support apparatus of claim 16, wherein the deck includes a post-receiving receptacle and the post of the footboard is removably received within the post-receiving receptacle when the footboard is coupled to the deck.

20. The patient support apparatus of claim 19, wherein the post-receiving receptacle is positioned under a mattress support surface of the deck.
